(19) United States
(12) Patent Application Publication
(10) Pub. No.: US 2026/0075663 A1
(43) Pub. Date: Mar. 12, 2026

(54) METHOD FOR SIMPLIFIED ATSSS OPERATIONS USING NULL ENCRYPTION OVER NON-3GPP ACCESS

(71) Applicant: CABLE TELEVISION LABORATORIES, INC., Louisville, CO (US)

(72) Inventors: Rahil Gandotra, Boulder, CO (US); Yunjung Yi, Vienna, VA (US); Florin Baboescu, Solana Beach, CA (US)

(21) Appl. No.: 19/326,323

(22) Filed: Sep. 11, 2025

Related U.S. Application Data
(60) Provisional application No. 63/693,541, filed on Sep. 11, 2024.

(51) Int. Cl. H04W 76/10; H04W 12/03; H04W 12/0431

(52) U.S. Cl. CPC H04W 76/10; H04W 12/03; H04W 12/0431

(57) ABSTRACT

Various systems, apparatuses, and methods for Establishment of multi-access (MA) protocol data unit (PDU) Sessions using multipath (MP) QUIC based steering, switching, and splitting are provided. A user equipment (UE) requests a MA PDU Session. A session management function (SMF) determines that only MP QUIC steering is used. The SMF signals a non-third generation partnership project (non-3GPP) interworking function (N3IWF) to set up one or more user plane resources over one or more internet protocol (IP) security (IP Sec) tunnels with null encryption. The MA PDU session excludes standard IPSec encryption for user data. The N3IWF performs internet key exchange (IKE) signaling with the UE to negotiate the one or more IP Sec tunnels with null encryption. The N3IWF transparently transmits user data without applying IPSec encryption.

### CROSS REFERENCE TO RELATED APPLICATIONS

This application claims the benefit of U.S. provisional application No. 63/693,541 filed on Sep. 11, 2024 which is incorporated by reference as if fully set forth.

### BACKGROUND OF THE INVENTION

In mobile networks, devices may connect to internet through multiple access technologies simultaneously, such as but not limited to 5G/6G and Wi-Fi. For this, the devices may use multi-access (MA) protocol data unit (PDU) Sessions. Protocols such as QUIC may be used to provide encryption between the devices and the networks. However, when untrusted connections like public Wi-Fi are used, data may be encrypted twice, which increases energy use or processing load. Therefore, there is a need for more efficient steering, switching, and splitting techniques without the unnecessary double encryption.

### SUMMARY OF THE INVENTION

In various implementations of the present disclosure, a method performed by a network device is provided. The method comprises receiving, from a user equipment (UE), a multi-access (MA) protocol data unit (PDU) Session Establishment Request. The method comprises determining, based on the MA PDU Session Establishment Request, that a MA PDU Session uses multipath (MP) QUIC based steering, switching, and splitting. The method comprises transmitting, to a non-third generation partnership project (non-3GPP) interworking function (N3IWF), a N2 PDU Session Request indicative of establishing one or more user plane resources for the MA PDU Session using one or more internet protocol (IP) security (IP Sec) tunnels with null encryption.

In an implementation, the N2 PDU Session Request is transmitted to the N3IWF via an access and mobility management function (AMF).

In an implementation, the N2 PDU Session Request indicates support for only MP QUIC based steering, switching, and splitting.

In an implementation, the N2 PDU Session Request comprises a field indicative of applying null encryption to user data associated with the MA PDU Session.

In an implementation, the MA PDU Session excludes standard IP Sec encryption.

In an implementation, the network device is a session management function (SMF).

In various implementations of the present disclosure, a network device is provided. The network device comprises a memory, a transceiver, and a processor. The transceiver and the processor are configured to receive, from a user equipment (UE), a multi-access (MA) protocol data unit (PDU) Session Establishment Request. The transceiver and the processor are configured to determine, based on the MA PDU Session Establishment Request, that a MA PDU Session uses multipath (MP) QUIC based steering, switching, and splitting. The transceiver and the processor are configured to transmit, to a non-third generation partnership project (non-3GPP) interworking function (N3IWF), a N2 PDU Session Request indicative of establishing one or more user plane resources for the MA PDU Session using one or more internet protocol (IP) security (IP Sec) tunnels with null encryption.

In an implementation, the N2 PDU Session Request is transmitted to the N3IWF via an access and mobility management function (AMF).

In an implementation, the PDU Session Establishment Request indicates support for only MP QUIC based steering, switching, and splitting.

In an implementation, the N2 PDU Session Request comprises a field indicative of applying null encryption to user data associated with the MA PDU Session.

In an implementation, the MA PDU Session excludes standard IP Sec encryption.

In an implementation, the network device is a session management function (SMF).

In various implementations of the present disclosure, a method performed by a network device is provided. The method comprises receiving, from an access and mobility management function (AMF), a N2 protocol data unit (PDU) Session Request for establishing a multi-access (MA) PDU Session associated with a user equipment (UE). The method comprises determining, based on the N2 PDU Session request, that the MA PDU Session is associated with only multipath (MP) QUIC based steering, switching, and splitting. The method comprises establishing one or more user plane resources for the MA PDU Session using one or more internet protocol (IP) security (IP Sec) tunnels with null encryption. The method comprises transmitting, to the AMF, a N2 PDU Session Response indicative of establishing the MA PDU Session.

In an implementation, the method further comprises performing internet key exchange (IKE) signaling with the UE to negotiate the one or more IP Sec tunnels with null encryption.

In an implementation, the method further comprises transmitting user plane data associated with the MA PDU Session transparently by excluding standard IP Sec encryption.

In an implementation, the network device is a non-third generation partnership project (non-3GPP) interworking function (N3IWF).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and 5G core (5GC);

FIG. 4 illustrates an example of a protocol stack for a user plane and a control plane;

FIG. 5A illustrates an example of a call flow diagram illustrating a user equipment (UE) initiated multi-access (MA) protocol data unit (PDU) Session Establishment method;

FIG. 5B illustrates an example of a call flow diagram illustrating a UE initiated MA PDU Session Establishment method

FIG. 6 illustrates an example flowchart for a method performed by a session management function (SMF) according to one or more implementations; and

FIG. 7 illustrates an example flowchart for a method performed by a non-3GPP interworking function (N3IWF) according to one or more implementations.

### DETAILED DESCRIPTION

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A UE may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

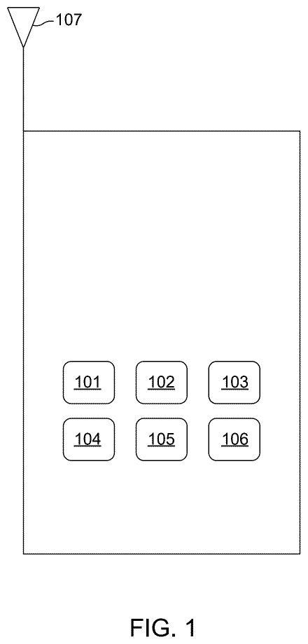

FIG. 1 is an illustration of an example device. In one case, the device may be a User Equipment (UE) suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous (e.g., different timing/spacing for UL or DL).

Different radio access technologies may be used with one or more transceivers (e.g., 802.11, WCDMA, CDMA2000, GSM, LTE, LTE-A, LTE-A Pro, NR etc.).

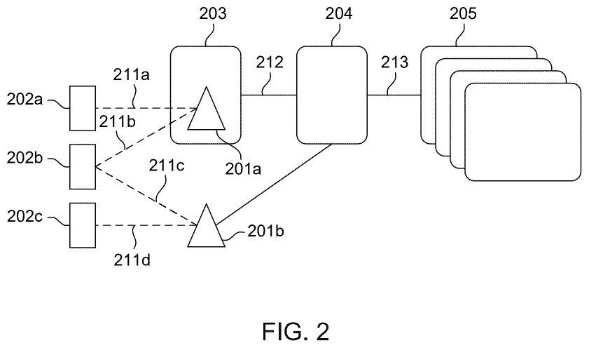

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

Generally, a communication system may use a combination of wired and wireless connections at different points in the system. One or more wireless technologies may (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network 206, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same RAT as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMF, one or more UPF, one or more Session Management Function (SMF), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

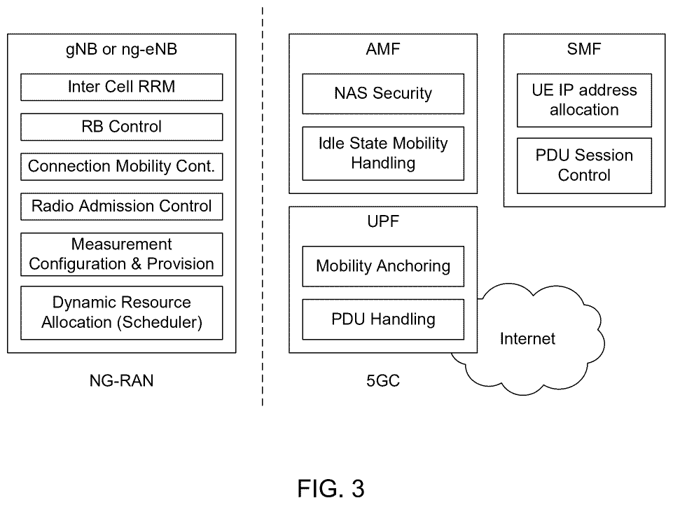

FIG. 3 illustrates an example of a functional split between the NG-RAN and 5GC. The AMF may be connected to one or more gNB the RAN via an N2 interface and may serve as a control node. For example, the AMF may be responsible for authenticating a support of the UE for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

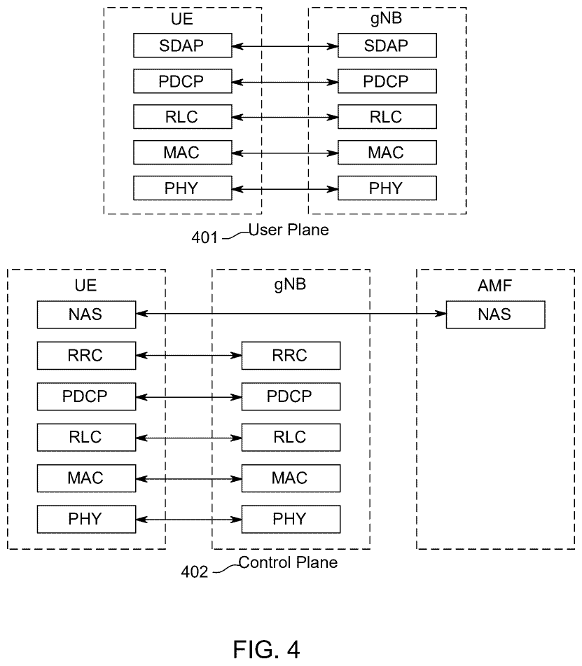

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1,Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

In various implementations of the present disclosure, one or more methods for simplified access traffic steering, switching and splitting (ATSSS) operations using null encryption over non-third generation partnership project (non-3GPP) access are provided. The one or more methods may include setting up, e.g., allocating one or more user plane resources over a non-3GPP access for a multi-access (MA) protocol data unit (PDU) Session using multipath (MP) QUIC based steering only. The MA PDU Session may use null-encryption for user plane internet protocol (IP) security (IP Sec) tunneling between a user equipment (UE) and a non-third generation partnership project (non-3GPP) interworking function (N3IWF).

In some cases, multi-access steering, splitting, and switching functionality (MASSS), one or more steering capabilities for ATSSS MA PDU Sessions for both IP and Ethernet are based on a QUIC transport between the UE and an anchoring user plane function (UPF). Each QUIC payload may be encrypted end to end between the UE and the UPF using transport layer security (TLS) encryption. As a result, when non-3GPP untrusted access is used as one of the MA PDU Session accesses, every data payload between the UE and the N3IWF is encrypted at least twice. This technique faces multiple drawbacks such as high energy consumption, high computation on the UE and in the network, and potential increase in packet latency due to extra computation for each packet.

The one or more methods of the present disclosure address the drawback of double encryption over an untrusted non-3GPP access for one or more MA PDU Sessions using multipath (MP) QUIC (MPQUIC) steering functionality.

In various implementations of the present disclosure, one or more mechanisms allow a UE and an N3IWF to establish a null encryption for one or more user plane IP Sec tunnels associated with a MA PDU Session based on determining that the UE and/or the N3IWF are notified by a network that the MA PDU Session uses MPQUIC steering functionality only.

In an implementation, a null encryption IPSec user plane tunneling for MA PDU Session using MPQUIC based steering, switching, and splitting provides simplified ATSSS architecture over non-3GPP access that eliminates IPSec tunnel encryption.

In an implementation, a method to establish one or more user plane resources over untrusted non-3GPP access for a MA PDU Session using only MPQUIC based steering, switching, and splitting functionality is provided. The network may determine that the one or more user plane resources may be established over the non-3GPP access for the MA PDU Session using MPQUIC based steering, switching, and splitting functionality, and the network may inform the N3IWF, via N2 signaling, to use null encryption for the user plane traffic associated with the MA PDU Session.

Upon receiving the notification, the N3IWF and the UE may use internet key exchange (IKE) signaling to establish the one or more IPSec tunnels with null encryption for the MA PDU Session user plane traffic between the UE and the N3IWF.

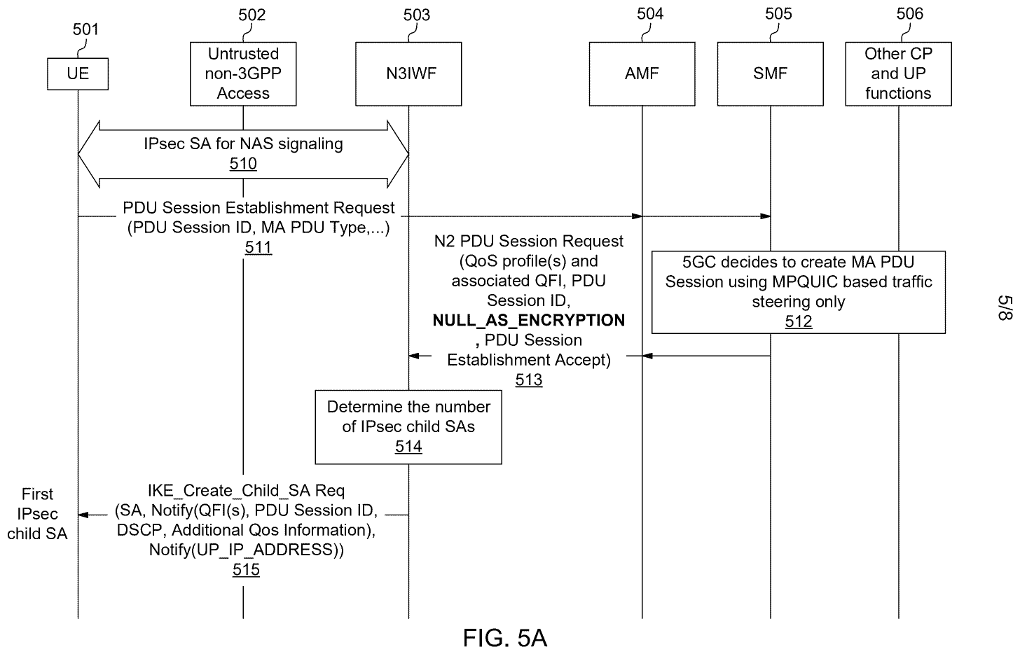

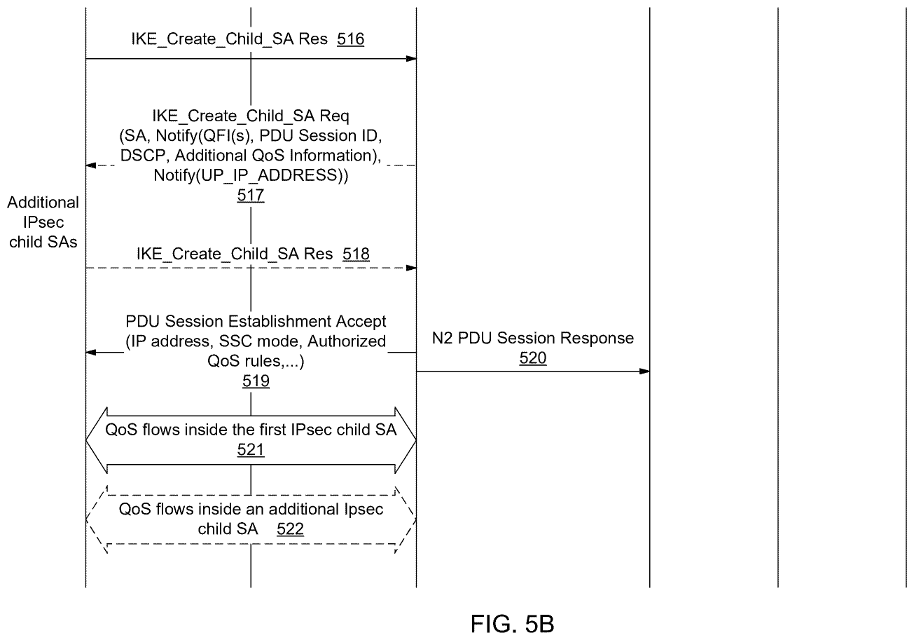

FIG. 5A and FIG. 5B illustrate an example of a call flow diagram illustrating a user equipment (UE) initiated PDU Session Establishment method according to one or more implementations. In this example method, a UE may initiate PDU Session Establishment with user plane resource allocation using one or more null encrypted IPSec tunnels over non-3GPP access. FIG. 5 illustrates a UE 501, an untrusted non-3GPP access 502, an N3IWF 503, an AMF 504, an SMF 505, and one or more control plane (CP) and user plane (UP) functions 506.

At 510, the UE 501 and the N3IWF 503 may negotiate one or more IP Sec security associations (SAs) of non-access stratum (NAS) signaling.

At 511, the UE 501 may transmit a PDU Session Establishment request to the SMF 505 via the AMF 504. The UE 501 may request the Establishment of a MA PDU Session using MPQUIC based steering, switching, and splitting capabilities for ATSSS.

At 512, 5GC (e.g. the SMF 505) may decide to create the MA PDU Session using MPQUIC based traffic steering only. The SMF 505, based on the PDU Session Establishment request and/or one or more network ATSSS capabilities, may determine to setup the MA PDU Session using only MPQUIC based steering, switching, and splitting.

At 513, the SMF 505 may transmit a PDU Session request to the N3IWF 503 via the AMF 504. The SMF 505 (via the AMF 504) may signal to the N3IWF 503 to setup one or more user plane resources for the MA PDU session using null encryption for one or more (or all) IPSec user plane tunnels.

At 514, 515, 516, 517, and 518, the N3IWF 503 and the UE 501 may use IKE signaling to establish the one or more IP Sec tunnels for user plane data using null encryption.

At 519, the N3IWF 503 may transmit a PDU Session Establishment Accept message to the UE 501.

At 520, the N3IWF 503 may transmit an N2 PDU Session Response message to the AMF 504.

At 521 and 522, the UE 501 and the N3IWF 503 may exchange user plane traffic e.g. one or more quality of service (QoS) flows in one or more IPSec child SAs.

In an implementation, the AMF 504 may support extension of the N2 PDU Session signaling between the AMF 504 and the N3IWF 503 with an optional field that indicates that the null encryption may be applied between the UE 501 and the N3IWF 503 for all the user plane traffic associated with the MA PDU Session.

In an implementation, the SMF 505 may support extension of the PDU Session signaling to the AMF 504 for indicating that only MPQUIC based steering is supported.

In an implementation, the N3IWF 503 may support extension of the N2 PDU Session signaling between the AMF 504 and the N3IWF 503 with the optional field that indicates that null user plane encryption may be applied for user plane traffic, between the UE 501 and the N3IWF 503, associated with this PDU Session.

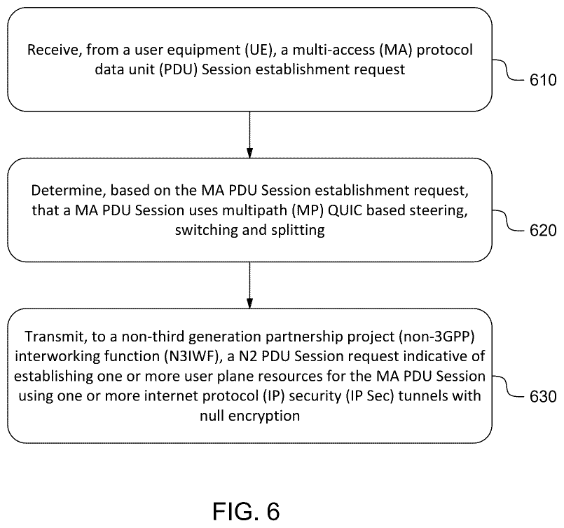

FIG. 6 illustrates an example flowchart for a method performed by an SMF according to one or more implementations described herein.

At 610, the SMF may receive, from a UE, a MA PDU Session Establishment Request.

At 620, the SMF may determine, based on the MA PDU Session Establishment Request, that the MA PDU Session uses MP QUIC based steering, switching, and splitting.

At 630, the SMF may transmit, to an N3IWF, a N2 PDU Session Request indicative of establishing one or more user plane resources for the MA PDU Session using one or more IP Sec tunnels with null encryption. The N2 PDU Session Request may be transmitted to the N3IWF via an AMF. The N2 PDU Session Request may comprise a field indicative of applying null encryption to user data associated with the MA PDU Session. The MA PDU Session may exclude standard IP Sec encryption.

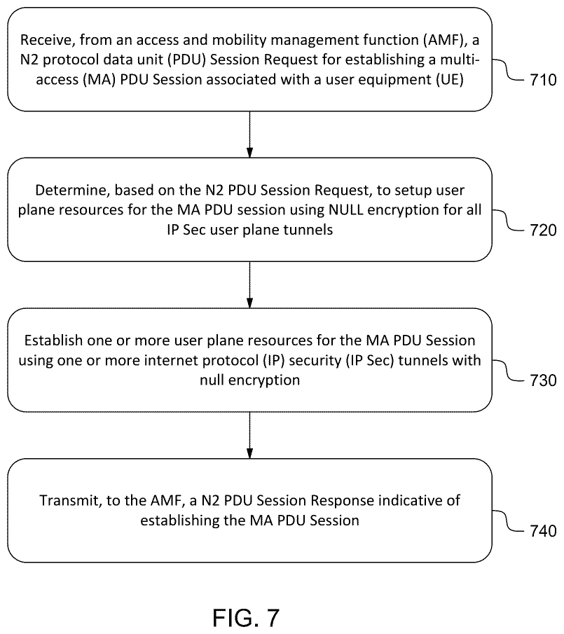

FIG. 7, illustrates an example flowchart for a method performed by an N3IWF according to one or more implementations described herein.

At 710, the N3IWF may receive, from an AMF, a N2 PDU Session Request for establishing an MA PDU Session associated with a UE.

At 720, the N3IWF may determine, based on the N2 PDU Session Request, that the MA PDU Session is associated with only MP QUIC based steering, switching, and splitting.

At 730, the N3IWF may establish one or more user plane resources for the MA PDU Session using one or more IP Sec tunnels with null encryption.

At 740, the N3IWF may transmit, to the AMF, a N2 PDU Session Response indicative of establishing the MA PDU Session. The N3IWF may perform IKE signaling with the UE to negotiate the one or more IP Sec tunnels with null encryption. The N3IWF may transmit user plane data associated with the MA PDU Session transparently by excluding standard IP Sec encryption.

In various implementations of the present disclosure, a method performed by a network device is provided. In an implementation, the network device is an SMF. The method comprises receiving, from a UE, a MA PDU Session Establishment Request. The method comprises determining, based on the MA PDU Session Establishment Request, that a MA PDU Session uses MP QUIC based steering, switching, and splitting. The method comprises transmitting, to a N3IWF, a N2 PDU Session Request indicative of establishing one or more user plane resources for the MA PDU Session using one or more IP Sec tunnels with null encryption. In an implementation, the MA PDU Session excludes standard IP Sec encryption.

In an implementation, the N2 PDU Session Request is transmitted to the N3IWF via an AMF. The N2PDU Session Request comprises a field indicative of applying null encryption to user data associated with the MA PDU Session.

In various implementations of the present disclosure, a network device is provided. In an implementation, the network device is an SMF. The network device comprises a memory, a transceiver, and a processor. The transceiver and the processor are configured to receive, from a UE, a MA PDU Session Establishment Request. The transceiver and the processor are configured to determine, based on the MA PDU Session Establishment Request, that a MA PDU Session uses MP QUIC based steering, switching, and splitting. The transceiver and the processor are configured to transmit, to an N3IWF, a N2 PDU Session Request indicative of establishing one or more user plane resources for the MA PDU Session using one or more internet protocol (IP) security (IP Sec) tunnels with null encryption. In an implementation, the MA PDU Session excludes standard IP Sec encryption.

In an implementation, the N2 PDU Session Request is transmitted to the N3IWF via an AMF. The N2PDU Session Request comprises a field indicative of applying null encryption to user data associated with the MA PDU Session.

In various implementations of the present disclosure, a method performed by a network device is provided. In an implementation, the network device is an N3IWF. The method comprises receiving, from an AMF, a N2 PDU Session Request for establishing a MA PDU Session associated with a UE. The method comprises determining, based on the N2 PDU Session Request, to setup user plane resources using null encryption for all IP Sec user plane tunnels. The method comprises establishing one or more user plane resources for the MA PDU Session using one or more IP Sec tunnels with null encryption. The method comprises transmitting, to the AMF, a N2 PDU Session Response indicative of establishing the MA PDU Session. The method further comprises performing IKE signaling with the UE to negotiate the one or more IP Sec tunnels with null encryption. The method further comprises transmitting user plane data associated with the MA PDU Session transparently by excluding standard IP Sec encryption.

What is claimed is:

1. A method performed by a network device, the method comprising:
receiving, from a user equipment (UE), a multi-access (MA) protocol data unit (PDU) Session Establishment Request;
determining, based on the MA PDU Session Establishment Request, that a MA PDU Session uses multipath (MP) QUIC based steering, switching, and splitting; and
transmitting, to a non-third generation partnership project (non-3GPP) interworking function (N3IWF), a N2 PDU Session Request indicative of establishing one or more user plane resources for the MA PDU Session using one or more internet protocol (IP) security (IP Sec) tunnels with null encryption.

2. The method of claim 1, wherein the N2 PDU Session Request is transmitted to the N3IWF via an access and mobility management function (AMF).

3. The method of claim 2, wherein the N2 PDU Session Request indicates support for only MP QUIC based steering, switching, and splitting.

4. The method of claim 1, wherein the N2 PDU Session Request comprises a field indicative of applying null encryption to user data associated with the MA PDU Session.

5. The method of claim 1, wherein the MA PDU Session excludes standard IP Sec encryption.

6. The method of claim 1, wherein the network device is a session management function (SMF).

7. A network device, comprising:
a memory;
a transceiver; and
a processor, wherein the transceiver and the processor are configured to:
receive, from a user equipment (UE), a multi-access (MA) protocol data unit (PDU) Session Establishment Request,
determine, based on the MA PDU Session Establishment Request, that a MA PDU Session uses multipath (MP) QUIC based steering, switching, and splitting, and
transmit, to a non-third generation partnership project (non-3GPP) interworking function (N3IWF), a N2 PDU Session Request indicative of establishing one or more user plane resources for the MA PDU Session using one or more internet protocol (IP) security (IP Sec) tunnels with null encryption.

8. The network device of claim 7, wherein the N2 PDU Session Request is transmitted to the N3IWF via an access and mobility management function (AMF).

9. The network device of claim 8, wherein the N2 PDU Session Request indicates support for only MP QUIC based steering, switching, and splitting.

10. The network device of claim 7, wherein the N2 PDU Session Request comprises a field indicative of applying null encryption to user data associated with the MA PDU Session.

11. The network device of claim 7, wherein the MA PDU Session excludes standard IP Sec encryption.

12. The network device of claim 7, wherein the network device is a session management function (SMF).

13. A method performed by a network device, the method comprising:
receiving, from an access and mobility management function (AMF), a N2 protocol data unit (PDU) Session Request for establishing a multi-access (MA) PDU Session associated with a user equipment (UE);
determining, based on the N2 PDU Session Request, that the MA PDU Session is associated with only multipath (MP) QUIC based steering, switching, and splitting;
establishing one or more user plane resources for the MA PDU Session using one or more internet protocol (IP) security (IP Sec) tunnels with null encryption; and
transmitting, to the AMF, a N2 PDU Session Response indicative of establishing the MA PDU Session.

14. The method of claim 13, further comprising:
performing internet key exchange (IKE) signaling with the UE to negotiate the one or more IP Sec tunnels with null encryption.

15. The method of claim 13, further comprising:
transmitting user plane data associated with the MA PDU Session transparently by excluding standard IP Sec encryption.

16. The method of claim 13, wherein the network device is a non-third generation partnership project (non-3GPP) interworking function (N3IWF).
